(19) United States
(12) Patent Application Publication
(10) Pub. No.: US 2018/0148950 A1
(43) Pub. Date: May 31, 2018

(54) WEED CONTROL SYSTEM

(71) Applicant: Kelly Hays, N. St Paul, MN (US)

(72) Inventor: Kelly Hays, N. St Paul, MN (US)

(21) Appl. No.: 15/364,786

(22) Filed: Nov. 30, 2016

(51) Int. Cl. E04H 17/06; A01M 21/00

(52) U.S. Cl. CPC E04H 17/063; A01M 21/00

(57) ABSTRACT

A weed control system includes a fence that extends upwardly from ground. A modular edging unit is provided and the modular edging unit is placed on the ground. The modular edging unit is positioned around each of the posts and beneath each of the segments. In this way the modular edging unit inhibits plant growth adjacent to the fence thereby enhancing an appearance of the fence.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98

The disclosure and prior art relates to weed control devices and more particularly pertains to a new weed control device for inhibiting weed growth beneath a fence.

### BRIEF SUMMARY OF THE INVENTION

An embodiment of the disclosure meets the needs presented above by generally comprising a fence that extends upwardly from ground. A modular edging unit is provided and the modular edging unit is placed on the ground. The modular edging unit is positioned around each of the posts and beneath each of the segments. In this way the modular edging unit inhibits plant growth adjacent to the fence thereby enhancing an appearance of the fence.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a modular edging unit of a weed control system according to an embodiment of the disclosure.

FIG. 2 is a front view of plate of an embodiment of the disclosure.

FIG. 3 is a perspective in-use view of an embodiment of the disclosure.

FIG. 4 is a perspective view of plate of an embodiment of the disclosure.

FIG. 5 is a right side perspective in-use view of an embodiment of the disclosure.

FIG. 6 is a cross sectional view taken along line 6-6 of FIG. 5 of an embodiment of the disclosure.

### DETAILED DESCRIPTION OF THE INVENTION

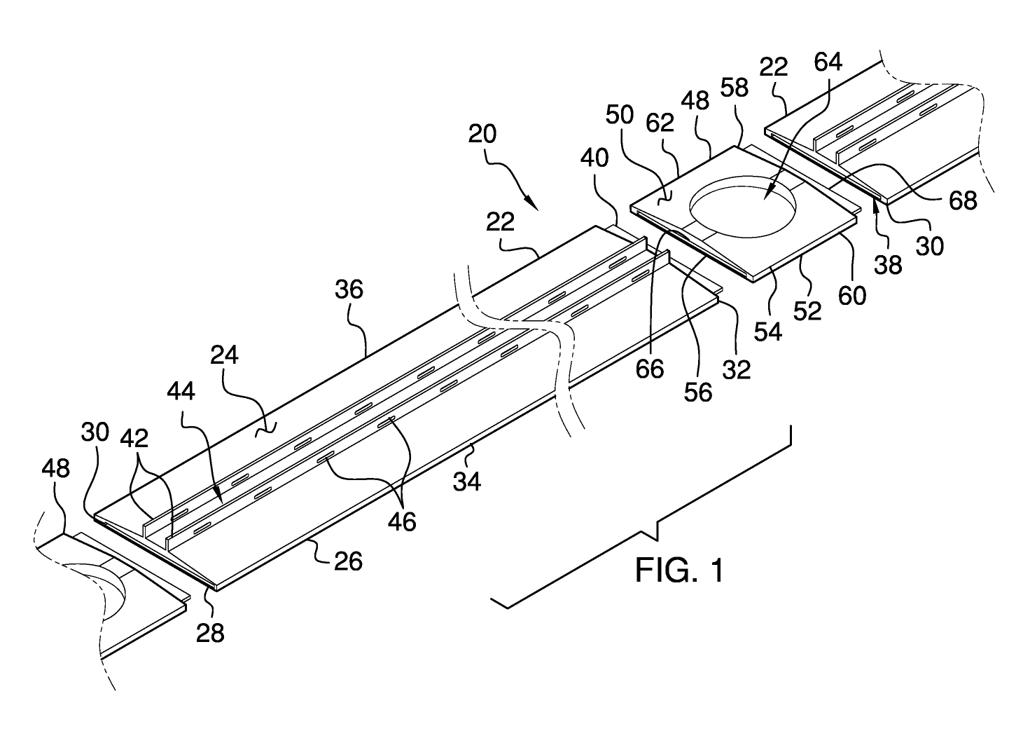

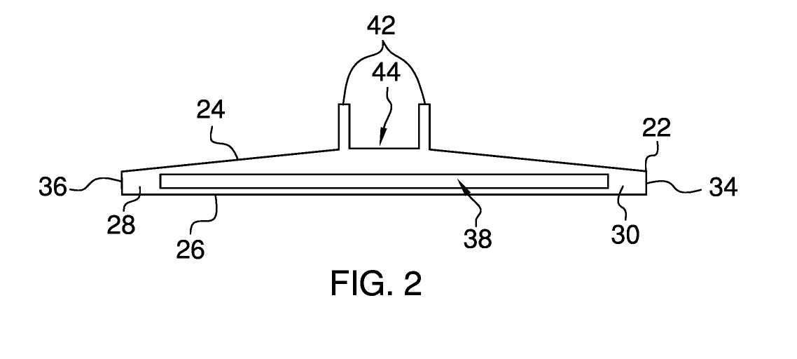

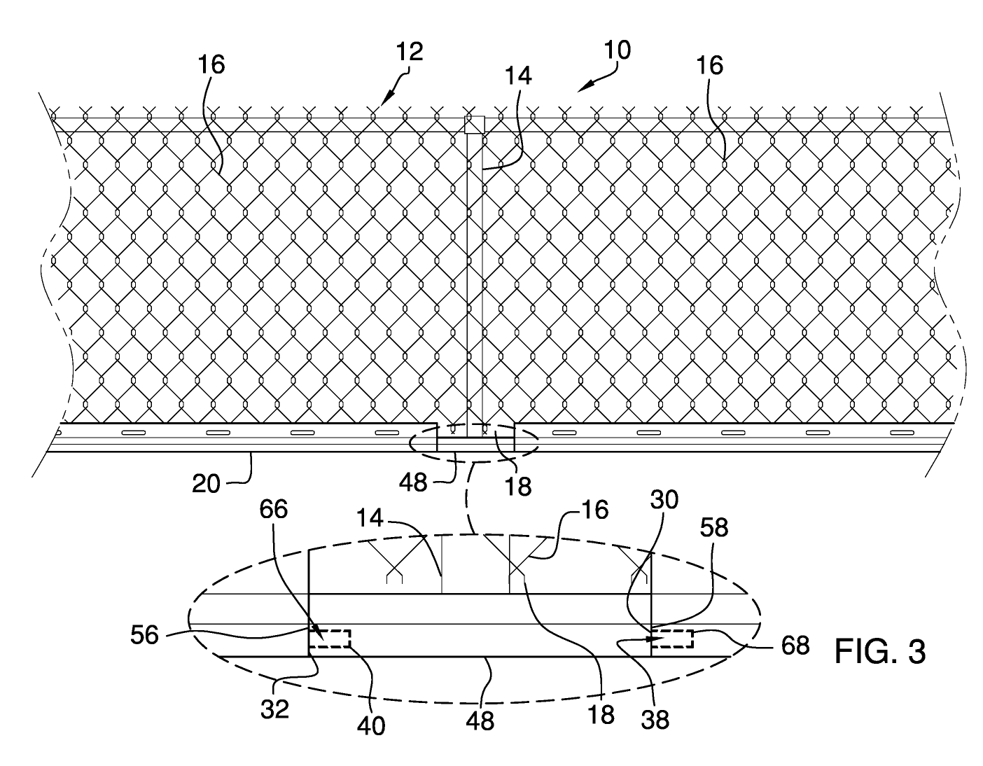

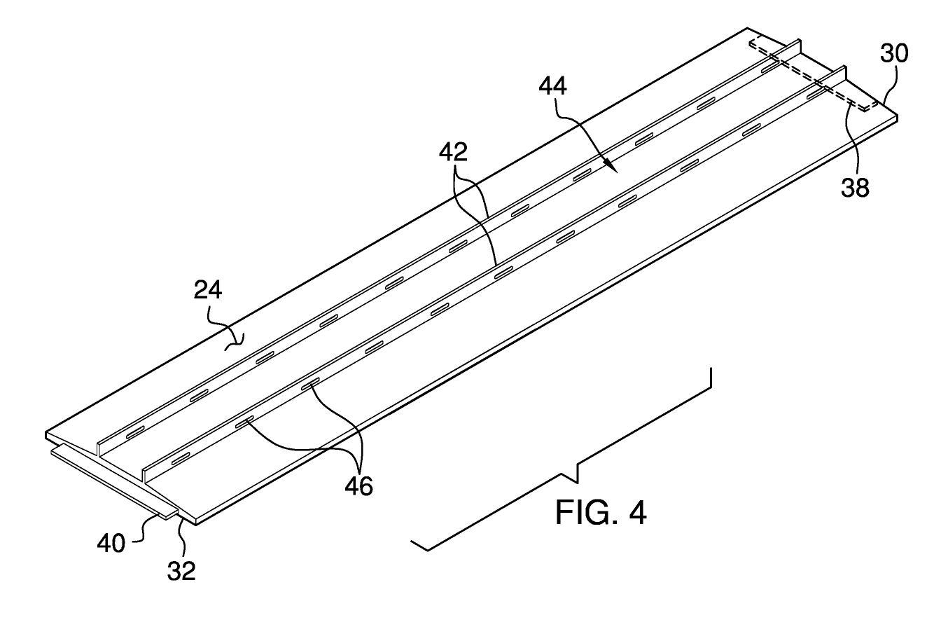

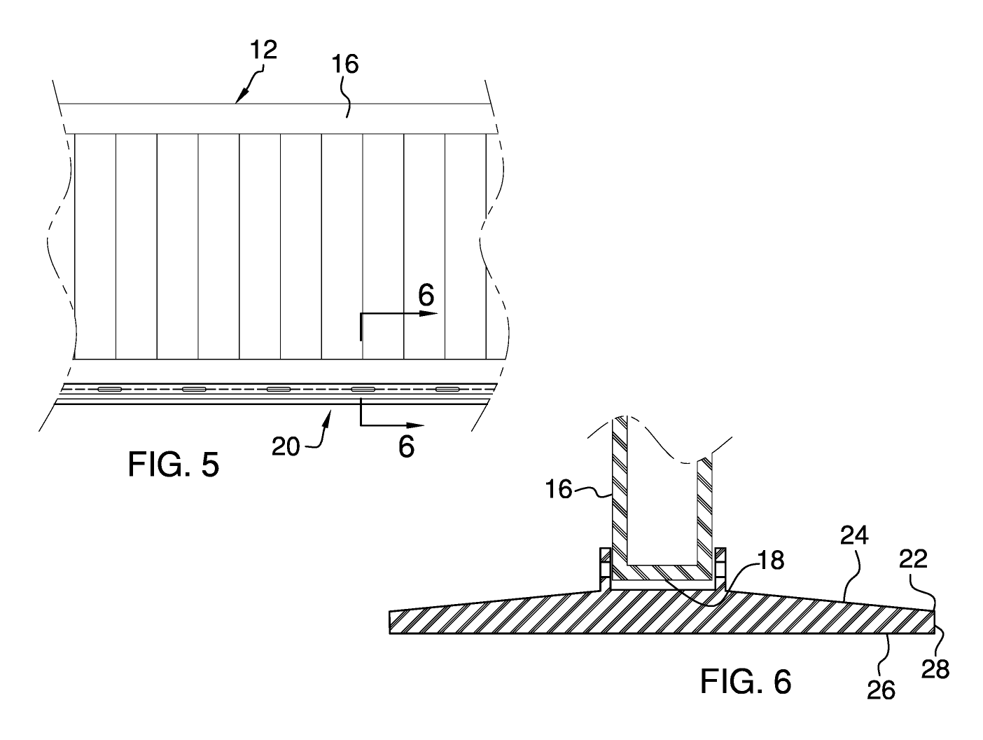

With reference now to the drawings, and in particular to FIGS. 1 through 6 thereof, a new weed control device embodying the principles and concepts of an embodiment of the disclosure and generally designated by the reference numeral 10 will be described.

As best illustrated in FIGS. 1 through 6, the weed control system 10 generally comprises a fence 12 that extends upwardly from ground. The fence 12 has a plurality of posts 14 and a plurality of segments 16. Each of the segments 16 extends between an associated pair of the posts 14 and each of the segments 16 has a lower edge 18. The fence 12 may be a chain link fence, a vinyl fence or any other fence of any conventional design.

A modular edging unit 20 is provided and the modular edging unit 20 is placed on the ground. Moreover, the modular edging unit 20 is positioned around each of the posts 14 and beneath each of the segments 16 to inhibit plant growth adjacent to the fence 12. In this way the modular edging unit 20 enhances the appearance of the fence 12. The modular edging unit 20 is comprised of a rigid and corrosion resistant material such as plastic or the like.

The modular edging unit 20 comprises a plurality of plates 22 and each of the plates 22 is positioned on the ground. Each of the plates 22 is aligned with the lower edge 18 corresponding to an associated one of the segments 16. Each of the plates 22 has a top surface 24, a bottom surface 26 and a peripheral edge 28 extending therebetween. The peripheral edge 28 has a front side 30, a back side 32, a first lateral side 34 and a second lateral side 36. Each of the plates 22 is elongated between the front side 30 and the back side 32 and the bottom surface 26 abuts the ground.

The front side 30 has a first well 38 extending toward the back side 32 and the back side 32 has a first tab 40 extending outwardly therefrom. The top surface 24 slopes downwardly between a longitudinal center line and each of the first lateral side 34 and the second lateral side 36. In this way the top surface 24 may shed water from precipitation, irrigation or any other source of water.

Each of the plates 22 includes a pair of walls 42 and each of the walls 42 is coupled to and extends upwardly from the top surface 24. Each of the walls 42 extends between the front side 30 and the back side 32 and each of the walls 42 is spaced apart from the longitudinal center line. Thus, a space 44 is defined between each of the walls 42 and the lower edge 18 corresponding to the associated segment 16 is positioned in the space 44. The space 44 may have a width ranging between 2.0 cm and 12.0 cm to accommodate a variety of widths of fences. Each of the walls 42 has a plurality of apertures 46 extending therethrough to drain that water from the space 44.

A plurality of panels 48 is provided and each of the panels 48 is positioned on the ground. Each of the panels 48 is removably coupled between an associated pair of the plates 22 and each of the panels 48 is positioned around an associated one of the posts 14. Each of the panels 48 has an upper surface 50, a lower surface 52 and a perimeter edge 54 extending therebetween. The perimeter edge 54 has a forward side 56, a rearward side 58, a first sidelong side 60 and a second sidelong side 62.

The upper surface 50 slopes downwardly between a longitudinal center line and each of the first sidelong side 60 and the second sidelong side 62 to shed water. Each of the panels 48 has an opening 64 extending through the upper surface 50 and the lower surface 52. The opening 64 insertably receives the associated post 14. The forward side 56 has a second well 66 extending toward the rearward side 58 and the second well 66 insertably receives the tab corresponding to an associated one of the plates 22. The rearward side 58 has a second tab 68 extending outwardly therefrom and the first well 38 corresponding to an associated one of the plates 22 insertably receives the second tab 68.

In use, the modular edging unit 20 is positioned on the ground to define a perimeter of the fence 12. In this way the modular edging unit 20 inhibits plant ground around the perimeter of the fence 12. Each of the panels 48 is positioned between the associated pair of the plates 22. Each of the posts 14 is inserted through the opening 64 in the associated panel. Each of the segments 16 is coupled between the posts 14 such that the lower edge 18 of the segments 16 is positioned in the space 44 corresponding to the associated plate. The first lateral side 34 and the second lateral side 36 corresponding to each of the plates 22 define a mowable edge on the ground. In this way a yard around the fence 12 may be mowed and otherwise maintained without contacting the fence 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed control system comprising:
a fence being configured to extend upwardly from ground; and
a modular edging unit being configured to be placed on the ground, said modular edging unit being positioned around each of said posts and beneath each of said segments wherein said modular edging unit is configured to inhibit plant growth adjacent to said fence thereby enhancing an appearance of said fence.

2. The system according to claim 1 wherein said fence has a plurality of posts and a plurality of segments, each of said segments extending between an associated pair of said posts, each of said segments having a lower edge.

3. The system according to claim 2, wherein said modular edging unit comprises a plurality of plates, each of said plates being configured to be positioned on the ground, each of said plates being aligned with said lower edge corresponding to an associated one of said segments.

4. The system according to claim 3, wherein each of said plates has a top surface, a bottom surface and a peripheral edge extending therebetween, said peripheral edge having a front side, a back side, a first lateral side and a second lateral side, each of said plates being elongated between said front side and said back side, said bottom surface being configured to abut the ground.

5. The system according to claim 4, wherein said front side has a first well extending toward said back side.

6. The system according to claim 4, wherein said back side has a first tab extending outwardly therefrom, said top surface sloping downwardly between a longitudinal center line and each of said first lateral side and said second lateral side wherein said top surface is configured to shed water.

7. The system according to claim 3, further comprising a pair of walls, each of said walls being coupled to and extending upwardly from said top surface, each of said walls extending between said front side and said back side, each of said walls being spaced apart from said longitudinal center line to define a space between each of said walls, said lower edge corresponding to said associated segment being positioned in said space.

8. The system according to claim 7, wherein each of said walls has a plurality of apertures extending therethrough wherein each of said apertures is configured to drain water from said space.

9. The system according to claim 2, wherein:
said modular edging unit comprises a plurality of plates, each of said plates having a first tab and a first well; and
said modular edge unit further comprises a plurality of panels, each of said panels being configured to be positioned on the ground, each of said panels being removably coupled between an associated pair of said plates, each of said panels being positioned around an associated one of said posts, each of said panels having an upper surface, a lower surface and a perimeter edge extending therebetween ,said perimeter edge having a forward side, a rearward side, a first sidelong side and a second sidelong side, said upper surface sloping downwardly between a longitudinal center line and each of said first sidelong side and said second sidelong side wherein said upper surface is configured to shed water.

10. The system according to claim 9, wherein each of said panels has an opening extending through said upper surface and said lower surface, said opening insertably receiving said post.

11. The system according to claim 9, wherein said forward side has a second well extending toward said rearward side, said second well insertably receiving said tab corresponding to an associated one of said plates.

12. The system according to claim 9, wherein said rearward side has a second tab extending outwardly therefrom, said first well corresponding to an associated one of said plates insertably receiving said second tab.

13. A weed control system comprising:
a fence being configured to extend upwardly from ground, said fence having a plurality of posts and a plurality of segments, each of said segments extending between an associated pair of said posts, each of said segments having a lower edge; and
a modular edging unit being configured to be placed on the ground, said modular edging unit being positioned around each of said posts and beneath each of said segments wherein said modular edging unit is configured to inhibit plant growth adjacent to said fence thereby enhancing an appearance of said fence, said modular edging unit comprising:
a plurality of plates, each of said plates being configured to be positioned on the ground, each of said plates being aligned with said lower edge corresponding to an associated one of said segments, each of said plates comprising:
a top surface, a bottom surface and a peripheral edge extending therebetween, said peripheral edge having a front side, a back side, a first lateral side and a second lateral side, each of said plates being elongated between said front side and said back side, said bottom surface being configured to abut the ground, said front side having a first well extending toward said back side, said back side having a first tab extending outwardly therefrom, said top surface sloping downwardly between a longitudinal center line and each of said first lateral side and said second lateral side wherein said top surface is configured to shed water,
a pair of walls, each of said walls being coupled to and extending upwardly from said top surface, each of said walls extending between said front side and said back side, each of said walls being spaced apart from said longitudinal center line to define a space between each of said walls, said lower edge corresponding to said associated segment being positioned in said space, each of said walls having a plurality of apertures extending therethrough wherein each of said apertures is configured to drain water from said space; and
a plurality of panels, each of said panels being configured to be positioned on the ground, each of said panels being removably coupled between an associated pair of said plates, each of said panels being positioned around an associated one of said posts, each of said panels having an upper surface, a lower surface and a perimeter edge extending therebetween ,said perimeter edge having a forward side, a rearward side, a first sidelong side and a second sidelong side, said upper surface sloping downwardly between a longitudinal center line and each of said first sidelong side and said second sidelong side wherein said upper surface is configured to shed water, each of said panels having an opening extending through said upper surface and said lower surface, said opening insertably receiving said post, said forward side having a second well extending toward said rearward side, said second well insertably receiving said tab corresponding to an associated one of said plates, said rearward side having a second tab extending outwardly therefrom, said first well corresponding to an associated one of said plates insertably receiving said second tab.
